(19) United States
(12) Patent Application Publication
(10) Pub. No.: US 2019/0328175 A1
(43) Pub. Date: Oct. 31, 2019

(54) Automated Air Fryer

(71) Applicant: Frederic Speed Bancroft, Baton Rouge, LA (US)

(72) Inventor: Frederic Speed Bancroft, Baton Rouge, LA (US)

(21) Appl. No.: 15/965,331

(22) Filed: Apr. 27, 2018

(51) Int. Cl. A47J 36/32; A47J 37/07; A47J 36/24

(52) U.S. Cl. CPC A47J 36/32; A47J 36/24; A47J 37/0745; A47J 37/0754

(57) ABSTRACT

The present invention is an automated system for the frying of food. It consists of two main subsystems. The physical machine which directly interacts with and cooks the food and the system software which monitor and interacts with the system sub-components to organize and arrange for the constant cooking of food. The system is able to manage the supply of cooked food to constantly meet the demands of the restaurant where the system is deployed. The system also monitors and manages the various system subcomponents to ensure that they are operational and functional.

### CROSS REFERENCE TO RELATED APPLICATIONS

Not applicable.

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of distributed systems. More specifically, it is in the field of distributed food management systems. And yet more specifically, it is in the field of automated food preparation systems

### DESCRIPTION OF RELATED ART

There are air frying systems however these can be difficult to manage and require staffing to constantly load and monitor the cooking apparatus to ensure that the food is cooked. These systems also require staffing and monitoring by an individual to ensure that there is enough food cooked to meet the current demands of the restaurant.

### GENERAL SUMMARY OF THE INVENTION

The present invention is an automated system for the frying of food. It consists of two main subsystems. The physical machine which directly interacts with and cooks the food and the system software which monitor and interacts with the system sub-components to organize and arrange for the constant cooking of food. The system is able to manage the supply of cooked food to constantly meet the demands of the restaurant where the system is deployed. The system also monitors and manages the various system subcomponents to ensure that they are operational and functional.

### DESCRIPTION OF FIGURES

FIG. 1 is a perspective view, which shows an exemplary hardware architecture of a computing device used in an embodiment of the invention.

FIG. 2 is a perspective view, which shows an exemplary logical architecture for a client device according to an embodiment of the invention.

FIG. 3 is a perspective view, which shows an exemplary architectural arrangement of clients, servers and external services, according to an embodiment of the invention.

FIG. 4 is a perspective view, which shows an embodiment of a hardware architecture of a computing device connected to a network used in various embodiments of the invention.

FIG. 5 is a perspective view, which shows Main view of Automated Fryer System.

FIG. 6 is a perspective view, which shows Perspective view of Frame.

FIG. 7 is a perspective view, which shows perspective view of cap.

FIG. 8 is a perspective view, which shows perspective view of cap 2 assembly.

FIG. 9 is a perspective view, which shows perspective view of hopper.

FIG. 10 is a perspective view, which shows bottom view of housing.

FIG. 11 is a perspective view, which shows perspective view of housing.

FIG. 12 is a perspective view, which shows perspective view of tray.

FIG. 13 is a perspective view, which shows perspective view of tray 2.

FIG. 14 is a perspective view, which shows perspective view of overall embodiment of system.

FIG. 15 is a perspective view, which shows a perspective view of the overall use of the system.

FIG. 16 is a diagram of Main Use.

FIG. 17 is a diagram of Checking if Food Needs to be Cooked.

FIG. 18 is a diagram of Cooking of Food.

FIG. 19 is a diagram of Admin Sets the System Up for Use.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

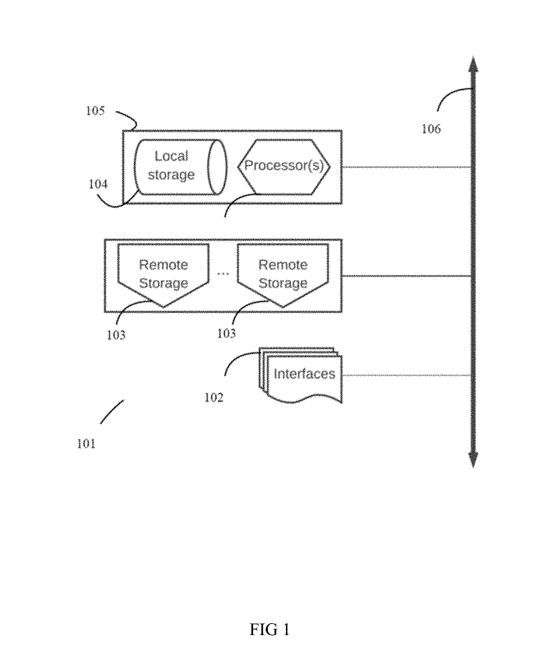

Referring now to FIG. 1, which shows an exemplary hardware architecture of a computing device used in an embodiment of the invention.

Computing device 101 comprises an electronic device capable of executing software- or hardware-based instructions according to one or more programs stored in memory. In some embodiments, it is thought that examples of computing device 101 may include: palmtop, carputers, game consoles, laptops, notebooks, desktop computers, tablet, smartphones, smartbooks, or server system utilizing cpu 105, local memory 104, and/or remote memory 103, and interface 102. Interface 102 comprises a mechanism to control the sending and receiving of data packets over a computer network or support peripherals used with the computing device 101. In some embodiments, it is thought that examples of interface 102 may include: BLUETOOTH™ interfaces, ethernet interfaces, frame relay interfaces, cable interfaces, DSL interfaces, token ring interfaces, graphics interfaces, universal serial bus (USB) interfaces, serial port interfaces, ethernet interfaces, FIREWIRE™ interfaces, THUNDERBOLT™ interfaces, PCI interfaces, parallel interfaces, radio frequency (RF) interfaces, network interface cards (NICs), near-field communications interfaces, 802.11 (WiFi) interfaces, frame relay interfaces, TCP/IP interfaces, ISDN interfaces, fast ethernet interfaces, Gigabit Ethernet interfaces, Serial ATA (SATA) or external SATA (ESATA) interfaces, high definition multimedia interface (HDMI), digital visual interface (DVI), analog or digital audio interfaces, asynchronous transer mode (ATM) interfaces, high-speed serial interface (HSSI) interfaces, Point of Sale (POS) interfaces, or fiber data distributed interfaces (FDDIs). Remote memory 103 comprises a service that provides users with a system for the backup, storage, and recovery of data. Local memory 104 comprises one or more physical devices used to store programs (sequences of instructions) or data (e.g. program state information) on a temporary or permanent basis for use in a computer or other digital electronic device, which may be configured to couple to the system in many different configurations. In some embodiments, it is thought that examples of local memory 104 may include: non-volatile random acess memory (RAM), read-only memory (ROM), or one or more levels of cached memory. Cpu 105 comprises a unit responsible for implementing specific functions associated with the functions of specifically configured computing device or machine. The central processing unit is an acronym which stands for cpu 105. In some embodiments, it is thought that examples of cpu 105 may include: system-on-a-chip (SOC) type hardware, Qualcomm SNAPDRAGON™, or Samsung EXYNOS™ CPU. Communications network 106 comprises a communications network that allows one or more computing device 101 to exhange data using known protocols. In some embodiments, it is thought that examples of communications network 106 may include: metropolitan area network, wireless personal area network, near-me area network, local area network, wireless local area network, wireless mesh network, wireless metropolitan area network, wireless wide area network, cellular network, home area network, storage area network, campus area network, backbone area network, personal area network, wide area network, enterprise private network, virtual private network, intranet, extranet, internetwork, Internet, near field communications, mobile telephone network, CDMA network, GSM cellular networks, or WiFi network.

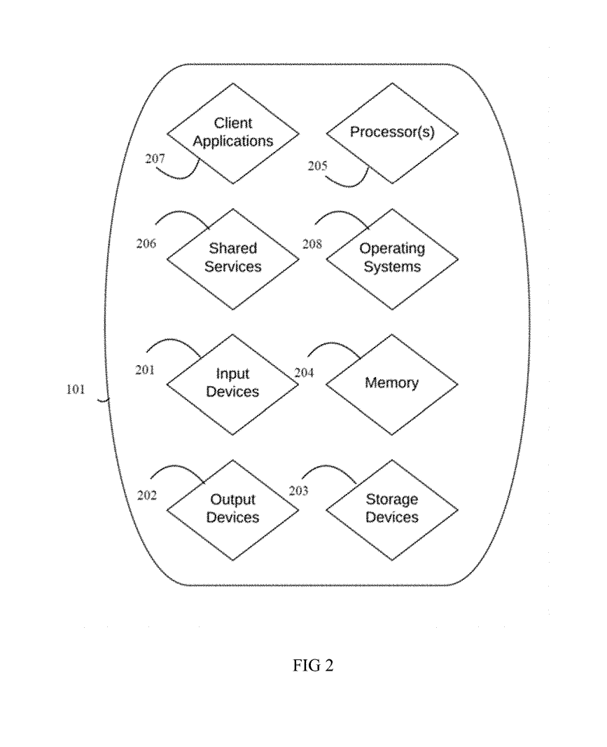

Referring now to FIG. 2, which shows an exemplary logical architecture for a client device according to an embodiment of the invention.

Input devices 201 comprises device of any type suitable for receiving user input. In some embodiments, it is thought that examples of input devices 201 may include: keyboard, touchscreen, microphone, mouse, touchpad, or trackball. Output devices 202 comprises device of any type suitable for outputting computing device 101 related information. In some embodiments, it is thought that examples of output devices 202 may include: screens for visual output, speakers, or printers. Storage devices 203 comprises a mechanism designed to store information which in some embodiments may be memory 204. In some embodiments, it is thought that examples of storage devices 203 may include: optical disks, hard disks, floppy disks, magnetic tape, optical media, CD-ROM disks, mageto-optical media, magnetic media, flash memory, solid state disks (SSD), “hybrid SSD” storage drives, swappable flash memory modules, thumb drives, removable optical storage discs, or electrical storage device. Memory 204 comprises mechanism designed to store program instructions, state information, and the like for performing various operations described herein, and may be storage devices 203 in some embodiments. In some embodiments, it is thought that examples of memory 204 may include: read-only memory (ROM), read-only memory (ROM) devices, memristor memory, random access memory (RAM), or RAM hadware modules. Processor 205 comprises a compent that performs the instructions and tasks involved in computer processing. In some embodiments, it is thought that examples of processor 205 may include: mobile processor, Qualcomm Processor, AMD Processor, application-specific integrated circuits (ASICs), electrically erasable programmable read-only memories (EEPROMs), field-programmable gate arrays (FPGAs), Intel Processor, microprocessor, microcontroller, microcomputer, programmable logic controller, or programmable circuit. Shared service 206 comprises web-enabled services or functionality related to a computing device 101. Client application 207 comprises a computing device 101 capable of obtaining information and applications from a server. Operating systems 208 comprises system software that manages computer hardware and software resources and provides common services for computer programs. In some embodiments, it is thought that examples of operating systems 208 may include: Microsoft Windows™, Apply's Mac OS/X, iOS operating systems, Linux operating system, or Google's Android™ operating system.

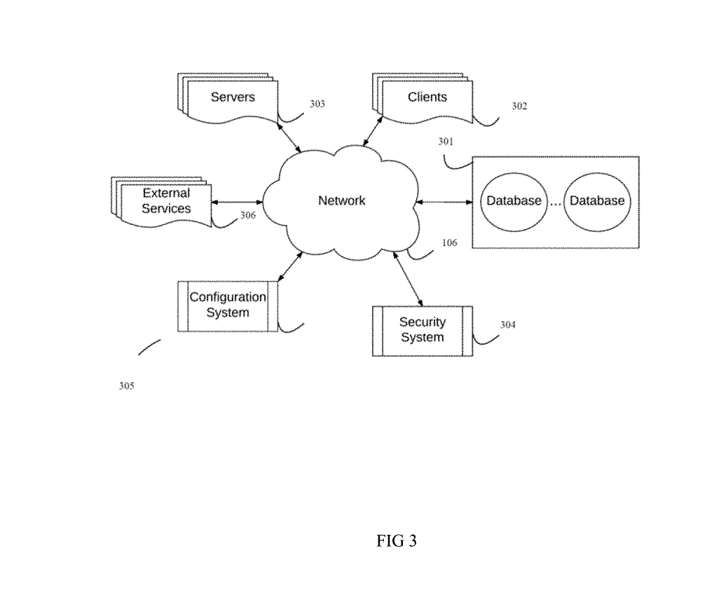

Referring now to FIG. 3, which shows an exemplary architectural arrangement of clients, servers and external services, according to an embodiment of the invention.

Database 301 comprises an organized collection of data within a program instructions related system, designed to allow the definition, creation, querying, update, and administration of databases. In some embodiments, it is thought that examples of database 301 may include: relational database system, NoSQL system, Hadoop system, Cassandra System, Google BigTable, column-oriented databases, in-memory databases, or clustered databases. Client 302 comprises one or more computing device 101 with program instructions for implementing a client-side portions of the present system which is some embodiments may be connected to a communications network 106. Server 303 comprises a computing device 101 configured to handle requests received from one or more client 302 over a communications network 106. Security system 304 comprises a system common to information technology (IT) and web functions that implements security related functions for the system. Distributed computing network 305 comprises any number of Client and/or Server operably connected to a communications network 106 for the purposes of implementing the system. External service 306 comprises web-enabled services or functionality related to or installed on a computing device 101 itself which may be deployed on one or more of a particular enterprises' or user's premises.

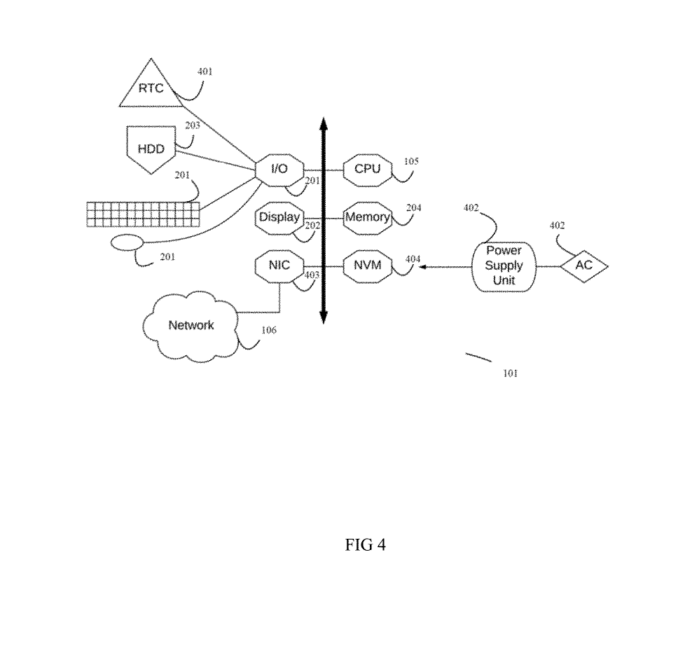

Referring now to FIG. 4, which shows an embodiment of a hardware architecture of a computing device connected to a network used in various embodiments of the invention.

Real time clock 401 comprises a computing device 101 clock (most often in the form of an integrated circuit) that keeps track of the current time. Power supply 402 comprises an electronic device that supplies electric energy to an electrical load. Nic 403 comprises a computer hardware component that connects a computer to a computer network. Non-volatile memory 404 comprises computer memory that can retrieve stored information even after having been power cycled (turned off and back on).

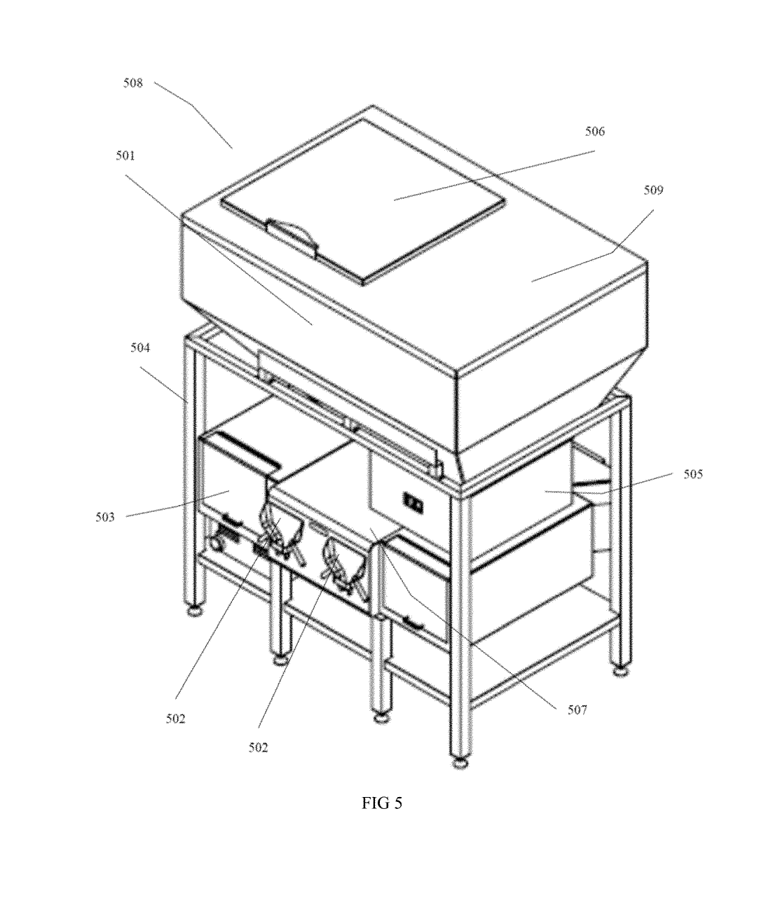

Referring now to FIG. 5, which shows Main view of Automated Fryer System.

Fridge AS 501 comprises an apparatus which keeps the uncooked food frozen and/or chilled and stores it prior to cooking. Fridge AS 501 interacts with food. Spatially, Fridge AS 501 is preferably positioned inside the Hopper AS 905. Fridge AS 501 functions to both 1) keeps the food at its precooked temperature and to 2) keep the food between 32 and 40 degrees. Fridge AS 501 preferably comprises Housing AS 1107, Hopper AS 905, and finally lid 1401.

Scoop 502 comprises an instrument that can be used to remove the cooked food from the Automated Air-Frying Machine 508. Scoop 502 is attached to Automated Air-Frying Machine 508. In some embodiments, the count of scoop 502 can be calculated by the number of portion sizes the user desires. In some embodiments, the count of scoop 502 has a preferred Count of 2. In some embodiments, it is thought that if scoop 502 is absent then another means can be used to remove food from the Automated Air-Frying Machine 508. Scoop 502 has an alternative embodiment herein termed robotic arm scoop. Scoop 502 comprises large scoop and medium scoop.

Food Warmer 503 comprises a device which maintains the temperature of the food at a set level until it is ready to be served to a customer. Food Warmer 503 interacts with food. Food Warmer 503 is mainly thought to be composed of Avantco W50. In some embodiments, it is thought that if Food Warmer 503 is absent then the food will immediately begin cooling upon its exit from the high heat conveyor oven 507 and thus would need to be served to a customer immediately upon completion of its cooking from the high heat conveyor oven 507. One goal of Food Warmer 503 to enable the Automated Air-Frying Machine 508 to cook a certain amount of food in advance of its actual need and store it at an optimal temperature until it is ready to be served. Food Warmer 503 has an alternative embodiment herein termed more than one compartment embodiment and another termed multi compartment food warmer embodiment.

Frame AS 504 comprises an apparatus which provides the structure and support for the components of the Automated Air-Frying Machine 508. Frame AS 504 is mainly thought to be composed of aluminum, however other embodiments may be composed of any of the following: plastic, titanium, PVC, or steel. In some embodiments, the volume of Frame AS 504 can be calculated by the size of the components which are attached to it. Frame AS 504 has many purposes which are as follows: First, the purpose of Frame AS 504 is to hold the weight and establish the positioning of the various components of the Automated Air-Frying Machine 508. Next, it serves to hold and support all of the components of the Automated Air-Frying Machine 508 and allows for them to be placed in their proper position for the functioning of the Automated Air-Frying Machine 508. Lastly, Frame AS 504 serves to allow for gravity to be used to help move the food through the Automated Air-Frying Machine 508. Frame AS 504 preferably comprises plate 605, shelf 608, tubes 614, and finally frame leveling mechanism 602.

Food dispenser 505 comprises an apparatus which moves food. Food dispenser 505 interacts with food. Food dispenser 505 is attached to Fridge AS 501, Frame AS 504, and high heat conveyor oven 507. Food dispenser 505 is mainly thought to be composed of RAM 16F. In some embodiments, it is thought that if food dispenser 505 is absent then then there is no means to control the rate of food that enters the high heat conveyor oven 507 from the Fridge AS 501.

Cap AS 506 comprises the removable top of the Fridge AS 501. Cap AS 506 is preferably shaped like a rectangle. In some embodiments, the length of Cap AS 506 can be calculated by the length of the plate cap aperture 802. In some embodiments, it is thought that if Cap AS 506 is absent then the Fridge AS 501 is exposed and the food stored within is exposed to the ambient room temperature. One goal of the Cap AS 506 is to seal the inside of the Fridge AS 501. Cap AS 506 preferably comprises base cap 703, plate cap 702, rib cap 704, and finally gasket 701.

High heat conveyor oven 507 comprises an oven which moves food products through a heated chamber at a variable speed via a conveyor belt. The conveyor belt speeds and temperatures are adjustable for consistent cooking of a high volume of similar products. The food is cooked using forced air impingement, radiant heat, or infrared heat. High heat conveyor oven 507 is mainly thought to be composed of a Turbo Chef HhC 2620. One goal of the high heat conveyor oven 507 is to cook the food at a high and efficient rate of speed and move the food in and out of the oven without any human involvement. High heat conveyor oven 507 has an alternative embodiment herein termed multiple conveyor embodiment and another termed multiple oven embodiment. High heat conveyor oven 507 preferably comprises oven, conveyor, and finally metal piece.

Automated Air-Frying Machine 508 comprises an apparatus which stores food that is ready to be cooked, cooks food and then stores the cooked food at an optimal serving temperatures until it is ready to be served. In some embodiments, the height has a preferred height of 74.25. In some embodiments, the width has a preferred width of 41.70. In some embodiments, the length has a preferred length of 56.00. Automated Air-Frying Machine 508 preferably comprises Frame AS 504, Tray 2 AS 1304, food warmer 503, scoop 502, bracket 1402, Tray AS 1201, Fridge AS 501, high heat conveyor oven 507, food dispenser 505, and finally sensor system 1515.

Cap 2 AS 509 comprises the top of the Fridge AS 501. Cap 2 AS 509 is preferably shaped like the shape of the top of the Fridge AS 501. One goal of Cap 2 AS 509 is to close off and seal the top of Fridge AS 501 while providing access to the Hopper AS 905. Cap 2 AS 509 comprises plate cap2 801 and plate bottom 803.

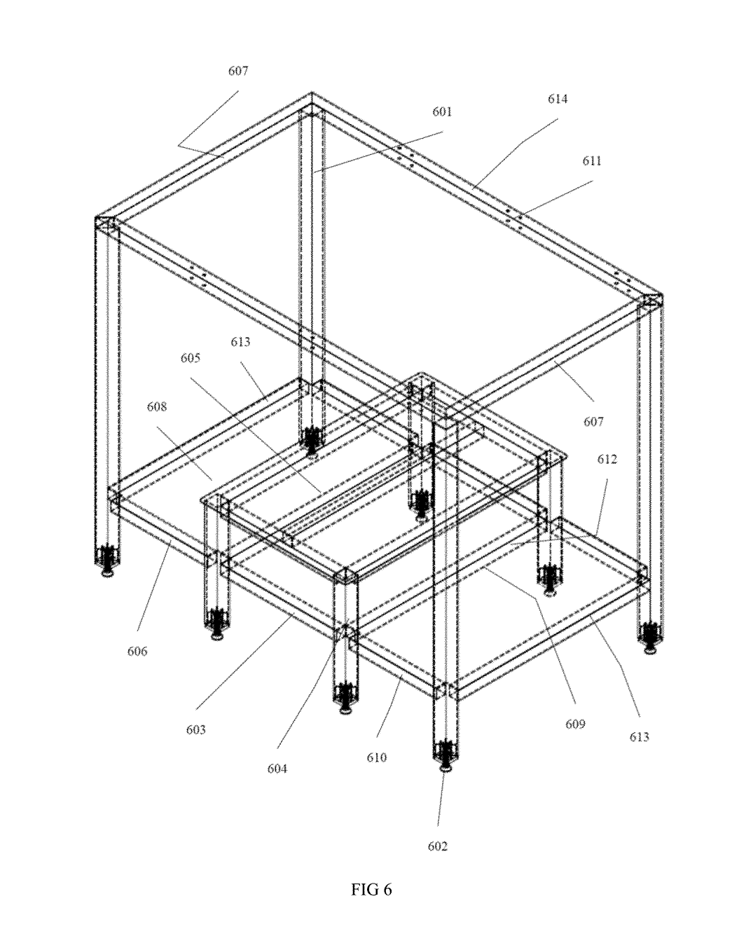

Referring now to FIG. 6, which shows perspective view of the Frame AS.

Frame leveling mechanism 602 comprises a system which ensures that the Frame AS 504 is level. One goal of frame leveling mechanism 602 is to ensure that the Frame AS 504 is level so that the food proceeds and move properly through the Automated Air-Frying Machine 508. Frame leveling mechanism 602 comprises level mount insert and level support.

Central tube 603 is attached to vertical tube central 604. Plate 605 comprises a surface to set various components on. Plate 605 is attached to Frame AS 504. Plate 605 is preferably shaped like rectangular. In some embodiments, the length has a preferred length of 23.5. In some embodiments, the width has a preferred width of 35.625. In some embodiments, it is thought that if plate 605 is absent then another attachment means is necessary to ensure that the components remain attached.

Left tube 606 is attached to vertical tube 601 and vertical tube central 604. Top cross tube 607 is attached to top tube 611.

Shelf 608 comprises a surface for which components of the Automated Air-Frying Machine 508 can be placed and set. Cross tube 609 comprises cross tube central 612 and cross tub edge 613. Right tube 610 is attached to vertical tube central 604 and vertical tube 601. In some embodiments, the height has a preferred height of 14. Top tube 611 is attached to top cross tube 607 and vertical tube 601. In some embodiments, the height has a preferred height of 56. Cross tube central 612 is attached to vertical tube central 604. Cross tub edge 613 is attached to vertical tube 601. Tubes 614 comprises the structural component of the Frame AS 504. Tubes 614 is preferably shaped like square. Tubes 614 is mainly thought to be composed of steel. In some embodiments, tubes 614 has a preferred width of 2 inches but in some embodiments, may range from a minimum of 1 inches to a maximum width of 3 inches. Tubes 614 preferably comprises top tube 611, central tube 603, vertical tube 601, left tube 606, vertical tube central 604, right tube 610, cross tube 609, and finally top cross tube 607.

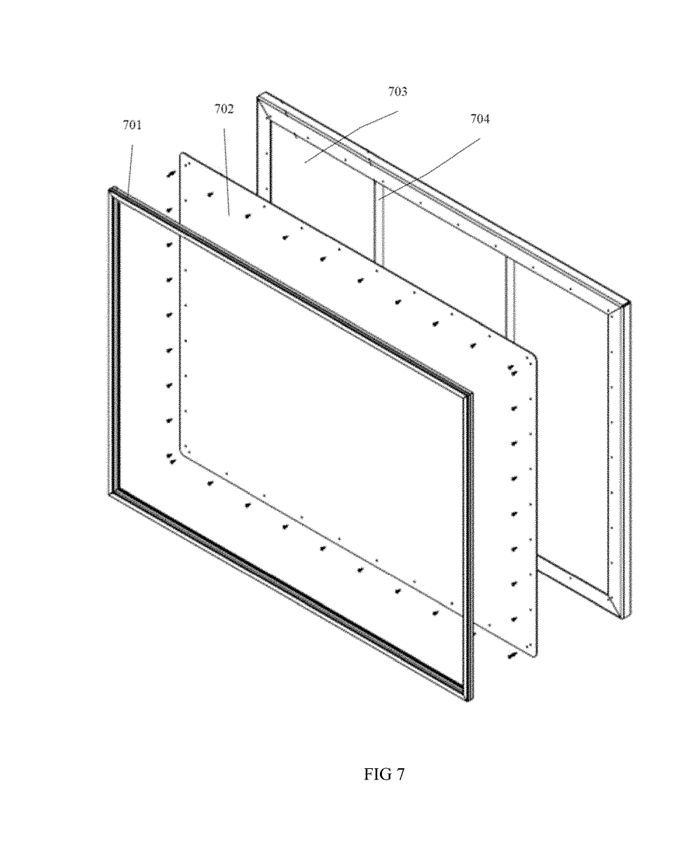

Referring now to FIG. 7, which shows perspective view of cap.

Gasket 701 comprises provides the seal between the cap and the Hopper AS 905. In some embodiments, the length of gasket 701 can be calculated by the same size as the plate cap2 801. In some embodiments, the height of gasket 701 can be calculated by the same size as the plate cap2 801. In some embodiments, it is thought that an example of gasket 701 may include Rubber and the like. One goal of gasket 701 is to provides a seal so that the inside of the Hopper AS 905 remains insulated and is not exposed to the outside air. Plate cap 702 is attached to rib cap 704. In some embodiments, the length has a preferred length of 38. Rib cap 704 comprises one or more rods that provide structural support for the plate cap2 801. Rib cap 704 is attached to plate cap2 801.

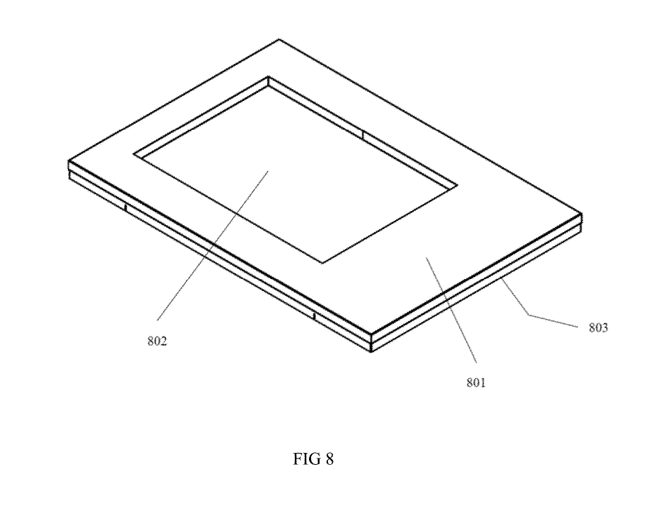

Referring now to FIG. 8, which shows perspective view of cap 2 assembly.

In some embodiments, the length has a preferred length of 56. Plate cap2 801 preferably comprises plate cap aperture 802. Spatially, plate cap aperture 802 is preferably positioned within the boundaries of the plate 605. In some embodiments, The length has a preferred length of 25. One goal of plate cap aperture 802 is to to allow for food to be placed into the Fridge AS 501 without having to remove the lid 1401. In some embodiments, the width of plate bottom 803 can be calculated by the same as the plate 605. In some embodiments, The width has a preferred width of 56. In some embodiments, the height of plate bottom 803 can be calculated by the same as the plate 605. In some embodiments, The height has a preferred height of 39.

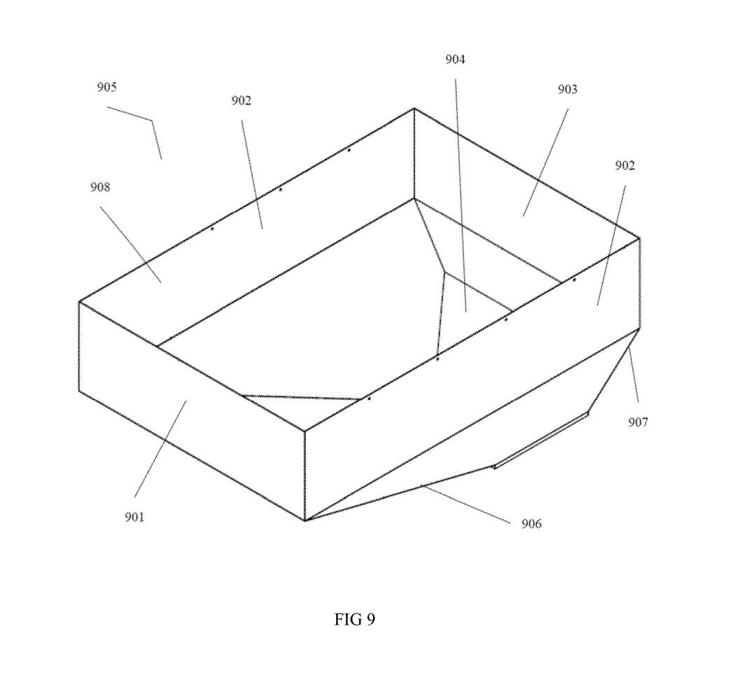

Referring now to FIG. 9, which shows perspective view of the Hopper AS.

Side plate left hopper 901 is attached to front-back plate hopper 902. Front-back plate hopper 902 comprises the front and back walls of the Hopper AS 905. In some embodiments, the height has a preferred height of 25. Front-back plate hopper 902 comprises inclined section of hopper 906 and inclined section of hopper 2 907.

Side plate hopper 903 is attached to front-back plate hopper 902. In some embodiments, it is thought that if plate hopper 904 is absent then the food would flow out of the hopper. One goal of plate hopper 904 is to act as the backstop that is set at an incline to direct the food into the food dispenser 505. Hopper AS 905 holds the food prior to cooking. In some embodiments, the volume of Hopper AS 905 can be calculated to be large enough to hold 100 lbs. of food. In some embodiments, the volume of Hopper AS 905 can be calculated by large enough to hold 600 lbs. of food. Hopper AS 905 preferably comprises Hopper Walls 908, hopper refrigerating mechanism, and finally food breakup mechanism.

Inclined section of hopper 906 comprises the section of the Hopper Walls 908 that creates an inclined surface of the floor of the Hopper AS 905. In some embodiments, inclined section of hopper 906 has a preferred length of 25 millimeters but in some embodiments, may range from a minimum of 15 millimeters to a maximum length of 90 millimeters. In some embodiments, the length of inclined section of hopper 906 can be calculated by enough so that the food slides down the path, but so steep so that the food clogs the food dispenser 505. One goal of inclined section of hopper 906 is to enables the food to be propelled out of the Hopper AS 905 and into the food dispenser 505 by gravity.

Inclined section of hopper 2 907 comprises the section of the Hopper Walls 908 that is set to an angle to provide a backstop for the food that is flowing out of the Hopper AS 905 and into the food dispenser 505. One goal of inclined section of hopper 2 907 is to provides a backstop for the food that so that it will be guided into the food dispenser 505. Hopper Walls 908 comprises Defines the outer walls of the Hopper AS 905. Hopper Walls 908 preferably comprises front-back plate hopper 902, side plate hopper 903, plate hopper 904, and finally side plate left hopper 901.

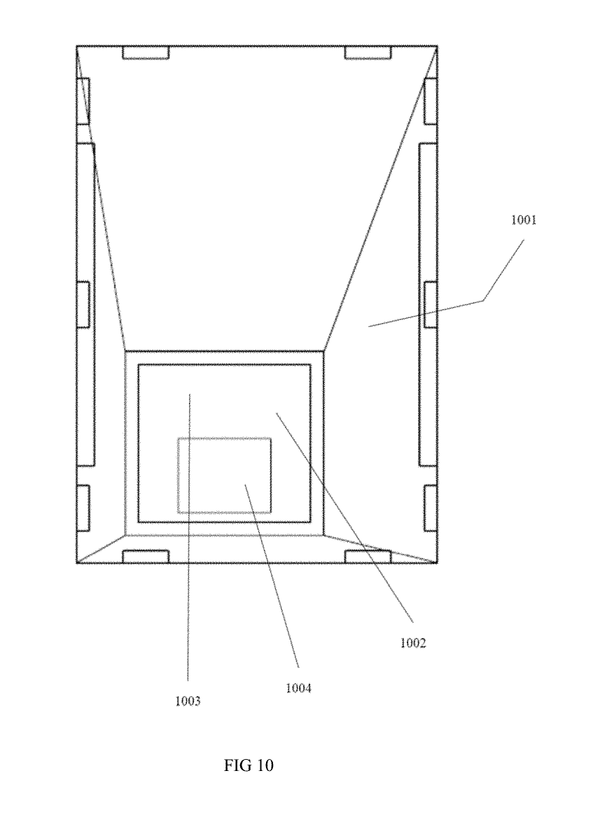

Referring now to FIG. 10, which shows the bottom view of the Housing AS.

Housing walls 1001 comprises the sides of the Housing AS 1107 which define its outer and inner structure. Housing walls 1001 preferably comprises side plate left fridge 1105, side plate fridge 1106, back plate fridge 1110, front plate fridge 1104, and finally housing bottom 1002.

Housing bottom 1002 comprises the bottom plate of the Housing AS 1107. Housing bottom 1002 comprises inner plate—housing and bottom plate—housing 1003. Bottom plate-housing 1003 comprises the outside facing plate. In some embodiments, the length has a preferred length of 20. In some embodiments, the width has a preferred width of 21.5.

Bottom plate—housing 1003 preferably comprises bottom plate aperture 1004. Spatially, bottom plate aperture 1004 is preferably positioned 2.5 inches from the edge of the bottom plate—housing 1003. In some embodiments, the width has a preferred width of 8. In some embodiments, the length has a preferred length of 10. One goal of bottom plate aperture 1004 is to allows the food to exit the Fridge AS 501.

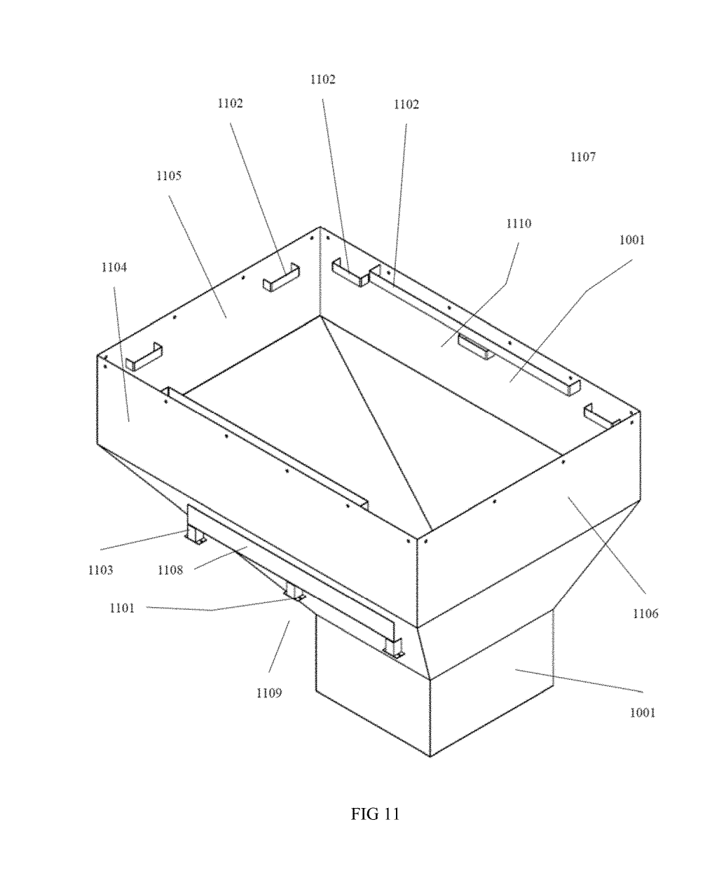

Referring now to FIG. 11, which shows perspective view of housing.

Plate—frame attachment structure 1101 comprises a piece that provides an attachment point for the Housing AS 1107 to the Frame AS 504. Plate—frame attachment structure 1101 is attached to Frame AS 504 and pipe 1103. Plate—frame attachment structure 1101 is preferably shaped like rectangle. In some embodiments, the width has a preferred width of 2.5. In some embodiments, the length has a preferred length of 1.375. One goal of plate-frame attachment structure 1101 is to provide a flat and stable surface for attaching the Housing AS 1107 to the Frame AS 504.

Bracket hopper 1102 comprises one or more attachment points on the Housing AS 1107 which holds and secures the Fridge AS 501 to the Housing AS 1107. Bracket hopper 1102 interacts with Hopper AS 905. Bracket hopper 1102 is attached to Housing AS 1107. One goal of bracket hopper 1102 is to provides a mounting and attachment point for the Hopper AS 905.

Pipe 1103 comprises a structural support beam that holds the weight of the Housing AS 1107 against the Frame AS 504. Pipe 1103 is attached to rib 1108. Pipe 1103 is preferably shaped like square. In some embodiments, the width has a preferred width of 1.375. In some embodiments, the length has a preferred length of 1.375. In some embodiments, the wall thickness has a preferred wall thickness of 0.065. One goal of pipe 1103 is to provide structural support for the Housing AS 1107 as it is attached to the Frame AS 504. In some embodiments, the height has a preferred height of 37. In some embodiments, the width has a preferred width of 55.88. In some embodiments, the width has a preferred width of 39. In some embodiments, the height has a preferred height of 37. In some embodiments, the width has a preferred width of 39.

Housing AS 1107 comprises the structure that surrounds, holds and insulates the Hopper AS 905 and is attached to the Frame AS 504. Housing AS 1107 is attached to Frame AS 504 and Fridge AS 501. Housing AS 1107 is mainly thought to be composed of steel. In some embodiments, it is thought that if Housing AS 1107 is absent then the Hopper AS 905 is exposed and is not insulated or supported properly. One goal of Housing AS 1107 is to enclose and insulate the Fridge AS 501. Housing AS 1107 preferably comprises bracket hopper 1102, housing walls 1001, and finally frame attachment structure 1109.

Rib 1108 comprises a beam or other support structure which holds the weight of the Housing AS 1107 in order to distribute it. Rib 1108 is attached to pipe 1103 and Housing AS 1107. One goal of rib 1108 is to distribute the weight of the Housing AS 1107 onto multiple pipe 1103.

Frame attachment structure 1109 attaches and secures the Housing AS 1107 to the Frame AS 504. Frame attachment structure 1109 is attached to Housing AS 1107. In some embodiments, it is thought that an example of frame attachment structure 1109 may include bolts and screws and the like. In some embodiments, it is thought that if frame attachment structure 1109 is absent then the Housing AS 1107 is not secured to the Frame AS 504 and could fall off. One goal of frame attachment structure 1109 is to hold and support the weight of the Housing AS 1107 and attach and secure the Housing AS 1107 to the Frame AS 504. Frame attachment structure 1109 preferably comprises pipe 1103, plate—frame attachment structure 1101, and finally rib 1108. In some embodiments, the width has a preferred width of 55.88.

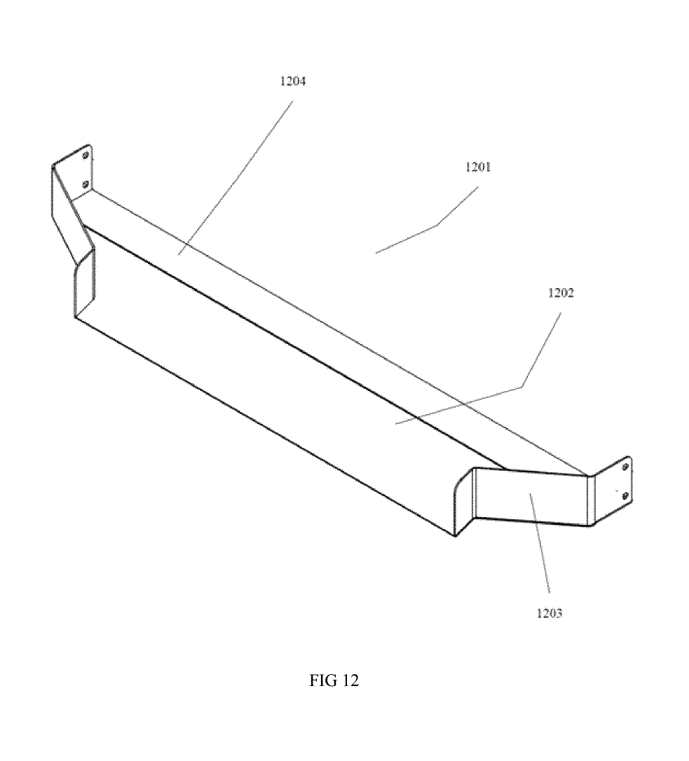

Referring now to FIG. 12, which shows perspective view of tray.

Tray AS 1201 transports the food from the food dispenser 505 to the high heat conveyor oven 507. Tray AS 1201 interacts with multiple entities: It interacts with food dispenser 505 and it also interacts with food. In some embodiments, it is thought that if Tray AS 1201 is absent then the food would not enter the high heat conveyor oven 507. Tray AS 1201 comprises base plate 1204 and side plate 1203. Tray base plate inclined section 1202 comprises an inclined portion of the base plate 1204. One goal of tray base plate inclined section 1202 is to enables the food to travel across the base plate 1204 via gravity. In some embodiments, the height has a preferred height of 4.81. In some embodiments, the length has a preferred length of 3.1. Base plate 1204 comprises the bottom plate of the tray. Base plate 1204 preferably comprises tray base plate inclined section 1202.

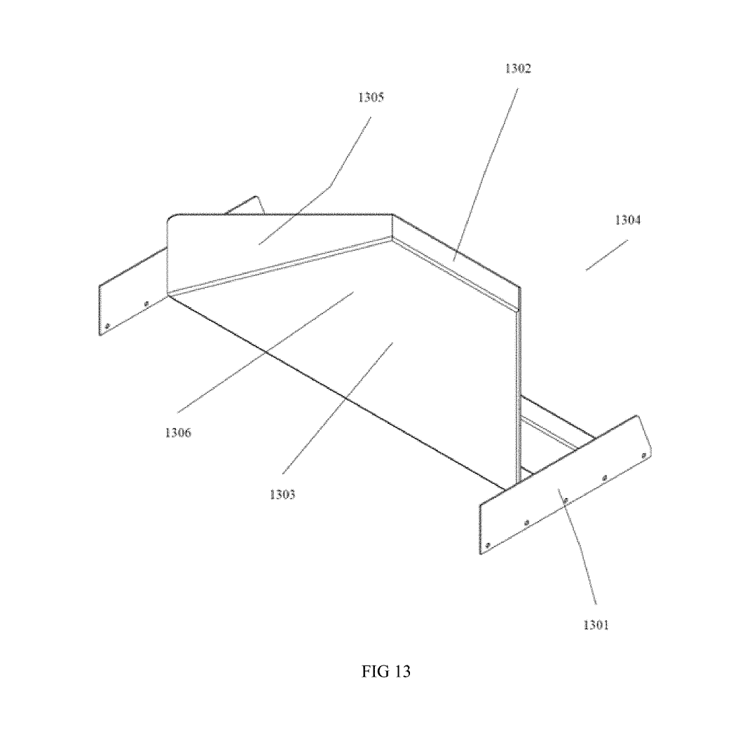

Referring now to FIG. 13, which shows perspective view of tray 2.

Plate—tray 2 1301 comprises a flat part which allows for the attachment to the frame as 504. In some embodiments, the width has a preferred width of 12. In some embodiments, the height has a preferred height of 3.

Rib—tray 2 1302 ensures that the food proceeds down the tray 2 1303 and does not head backwards. In some embodiments, the width has a preferred width of 3.0625. One goal of rib—tray 2 1302 is to provide an attachment means for the Tray 2 AS 1304.

Tray 2 1303 comprises a flatter portion that the food travels across. In some embodiments, the width has a preferred width of 29.77. Tray 2 1303 comprises Tray 2 AS walls 1305 and tray 2 bottom 1306.

Tray 2 AS 1304 transports the cooked food from the high heat conveyor oven 507 to the food warmer 503. Tray 2 AS 1304 interacts with food. Tray 2 AS 1304 is attached to high heat conveyor oven 507. In some embodiments, it is thought that if Tray 2 AS 1304 is absent then the food would not be directed to the food warmer 503. One goal of Tray 2 AS 1304 is to use gravity to transport the food from the high heat conveyor oven 507 to the food warmer 503. Tray 2 as 1304 preferably comprises tray 2 1303, rib-tray 2 1302, and finally plate-tray 2 1301. Tray 2 as walls 1305 comprises the sides of the tray 2 1303. One goal of tray 2 as walls 1305 is to keep the food from falling off of the tray 2 as 1304. Tray 2 bottom 1306 comprises the bottom of the tray 2 1303 that is positioned at an incline realtive to the top and bottom f the tray 2 as 1304. Tray 2 bottom 1306 functions to both 1) provides the surface that the food can travel on as it passes across the tray 2 as 1304 and to 2) the incline of the tray 2 bottom 1306 enables gravity to move the food across the tray 2 as 1304.

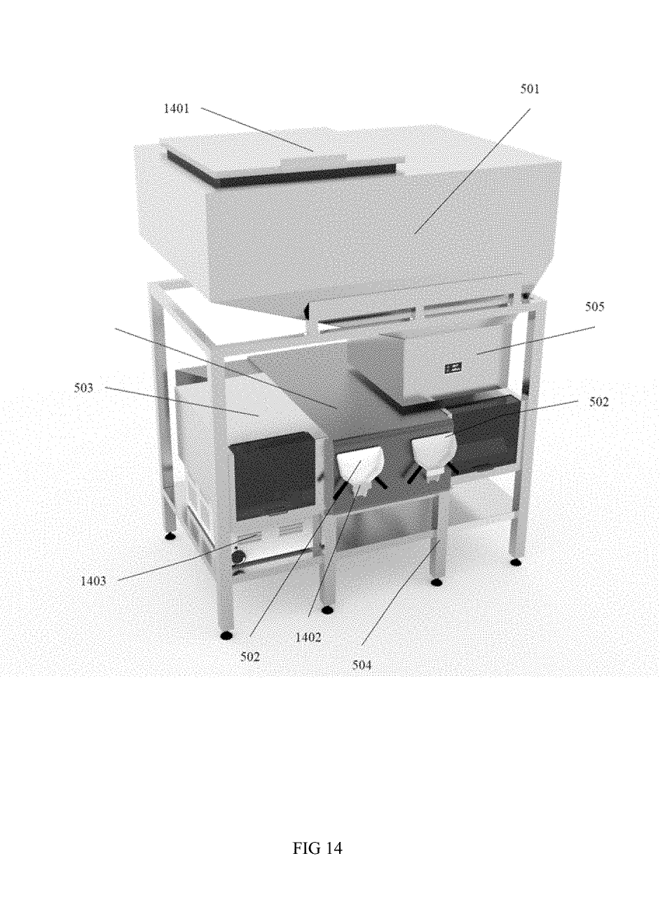

Referring now to FIG. 14, which shows perspective view of overall embodiment of system.

Lid 1401 closes off and insulates the contents of the Fridge AS 501. Spatially, lid 1401 is preferably positioned on the top of the Fridge AS 501 and on the side of the Fridge AS 501. In some embodiments, the width of lid 1401 can be calculated by the width of the Fridge AS 501. In some embodiments, the length of lid 1401 can be calculated by the length of the Fridge AS 501. Lid 1401 comprises Cap 2 AS 509 and Cap AS 506.

Bracket 1402 comprises an apparatus which attaches the scoop 502 to the Automated Air-Frying Machine 508. Bracket 1402 interacts with scoop 502. Bracket 1402 is attached to Automated Air-Frying Machine 508. In some embodiments, the count has a preferred count of 2. In some embodiments, it is thought that if bracket 1402 is absent then another attachment means is used to attach the scoop to the Automated Air-Frying Machine 508 or there is no means to attach the scoop 502 to the Automated Air-Frying Machine 508.

Sensor box 1403 comprises an apparatus which measures the amount of food present in the Food Warmer 503 at a given instance in time. Sensor box 1403 interacts with food warmer 503. Sensor box 1403 is attached to food warmer 503. Sensor box 1403 is mainly thought to be composed of weight sensor, however other embodiments may be composed of any of the following: optical sensor, camera, or heat sensor camera. In some embodiments, it is thought that if sensor box 1403 is absent then a manual means such as a timer or a button press can be used to signal that more food should be moved from the Fridge AS 501 to the high heat conveyor oven 507. One goal of sensor box 1403 is to enables the Automated Air-Frying Machine 508 to monitor the amount of food that is present in the Food Warmer 503 at a given instance in time so that the Automated Air Fryer System Analyzer 1501 can analyze that data and determine whether more food needs to be processed through the Automated Air-Frying Machine 508.

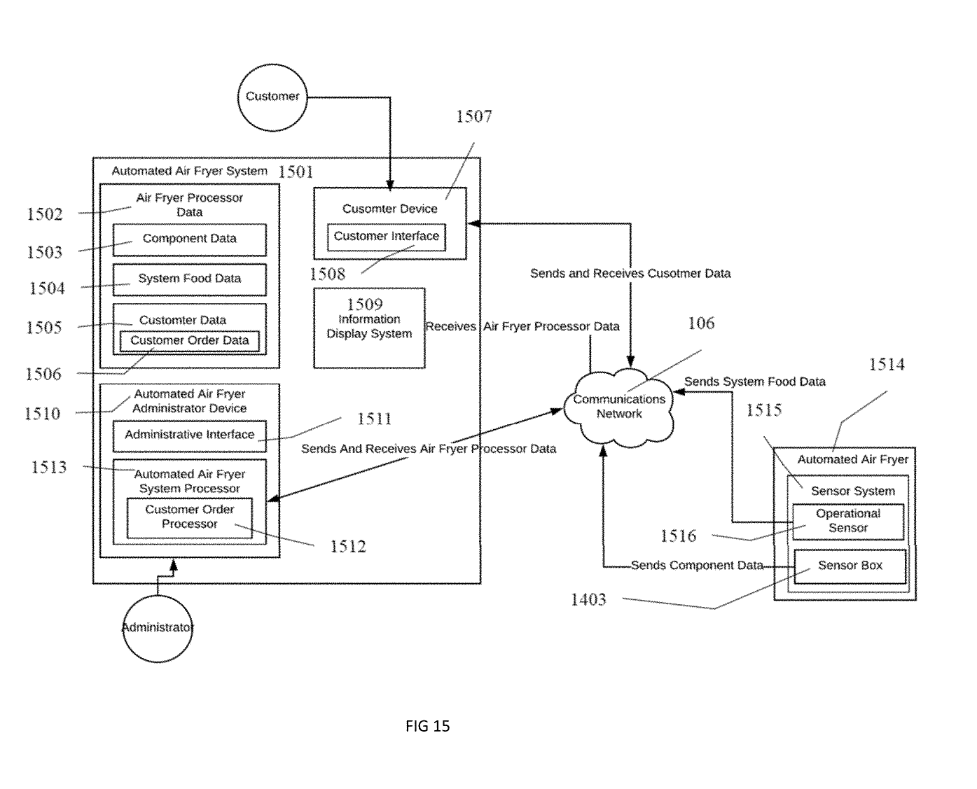

Referring now to FIG. 15, which shows the overall use of the Automated Air Fry System Analyzer.

Automated Air Fryer System Analyzer 1501 comprises automates the cooking of food in the automated air fryer 1514. One goal of Automated Air Fryer System Analyzer 1501 is to enable the Automated Air-Frying Machine 508 to cook and process enough food to meet the needs of its use case. Automated Air Fryer System Analyzer 1501 preferably comprises information display system 1509, Air Fryer Processor Data 1502, customer device 1507, and finally automated air fryer administrator device 1510.

Air Fryer Processor Data 1502 comprises data or data object which stores information regarding the Automated Air-Frying Machine 508. Air Fryer Processor Data 1502 preferably comprises system food data 1504, customer data 1505, and finally component data 1503. Component data 1503 comprises data or data object which stores information regarding the operational status of a component of the Automated Air-Frying Machine 508. In some embodiments, it is thought that examples of component data 1503 may include: oven temp, operational status, freezer temperature, or fridge temperature.

System food data 1504 comprises data or data object which stores information regarding the food in the Automated Air-Frying Machine 508. In some embodiments, it is thought that examples of system food data 1504 may include: Temperature Data, Amount of Cooked Food, or Amount of Food that is being cooked. Customer data 1505 comprises data or data object which stores information about a customer. In some embodiments, it is thought that an example of customer data 1505 may include name and the like. Customer data 1505 preferably comprises customer order data 1506. Customer order data 1506 comprises data or data object which stores information regarding a specific order. In some embodiments, it is thought that an example of customer order data 1506 could be cooked food temperature or perhaps units of food ordered and the like.

Customer device 1507 comprises a computing device 101 for use by customer for inputting customer data 1505. In some embodiments, it is thought that an example of customer device 1507 could be Point of Sale (POS) or perhaps Mobile Device and the like. Customer device 1507 preferably comprises customer interface 1508. One goal of customer interface 1508 is to enables the customer data 1505 to accept and receive orders from a customer. Information display system 1509 comprises a computing device 101 which displays Air Fryer Processor Data 1502 to the user. In some embodiments, it is thought that examples of information display system 1509 may include: LCD, OLED Screen, or Television. One goal of information display system 1509 is to displays information to outside users about the system. Automated air fryer administrator device 1510 comprises a computing device 101 which sends and receives Air Fryer Processor Data 1502. Automated air fryer administrator device 1510 comprises Automated Air Fryer System Processor 1513 and Administrative Interface 1511. Administrative Interface 1511 comprises a graphical user interface which displays Air Fryer Processor Data 1502 and allows for the input of Air Fryer Processor Data 1502. Administrative Interface 1511 functions to both 1) enable an administrator to configure and utilize the automated air fryer 1514 and to 2) enables an administrator to manually signal the automated air fryer 1514 that another batch of food needs to be cooked.

Customer order processor 1512 sends and receives customer order data 1506 via a communications network 106 and associates customer order data 1506 with a specific instance of customer data 1505. One goal of customer order processor 1512 is to enable the Automated Air Fryer System Processor 1513 to track and store the information regarding a specific instance of customer order data 1506. Automated Air Fryer System Processor 1513 comprises sends and receives Air Fryer Processor Data 1502 via a communications network 106. One goal of Automated Air Fryer System Processor 1513 is to analyzes system food data 1504. Automated Air Fryer System Processor 1513 preferably comprises customer order processor 1512. Automated air fryer 1514 comprises Automated Air-Frying Machine 508 and Automated Air Fryer System Analyzer 1501. Sensor system 1515 comprises one or more devices which monitor the operational status of the components of the Automated Air-Frying Machine 508 and/of the food that has been cooked in the Automated Air-Frying Machine 508. Sensor system 1515 comprises sensor box 1403 and operational sensor 1516. Operational sensor 1516 comprises determines the operating status of a component in the Automated Air-Frying Machine 508.

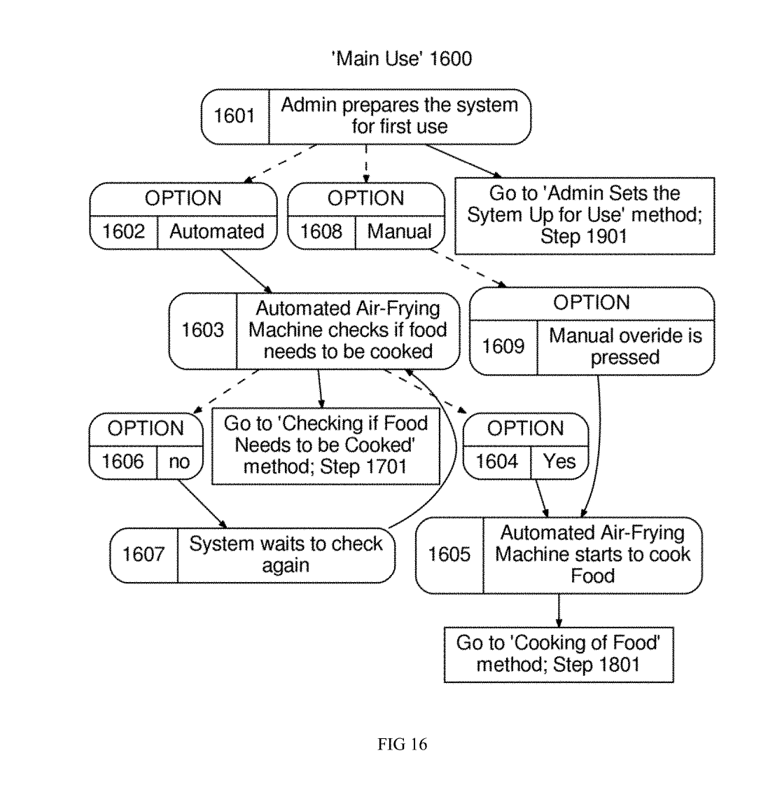

Referring now to FIG. 16, which shows Main Use of the Automated Air Fryer System.

In a first step, admin prepares the system for first use (Step 1601). Step 1601 is further detailed below in a related method (1900—‘Admin Sets the Sytem Up for Use’). If Automated (Step 1602), then Automated Air-Frying Machine 508 checks if food needs to be cooked (Step 1603). Step 1603 is further detailed below in a related method (1700—‘Checking if Food Needs to be Cooked’). If Yes (Step 1604), then Automated Air-Frying Machine 508 starts to cook food (Step 1605). Step 1605 is further detailed below in a related method (1800—‘Cooking of Food’). From Step 1603, if no (Step 1606), then System waits to check again (Step 1607). Next, refer to Step 1603. Step 1603 is further detailed below in a related method (1700—‘Checking if Food Needs to be Cooked’). From Step 1601, if Manual (Step 1608), and if Manual override is pressed (Step 1609), then refer to Step 1605. then Step 1605 is further detailed below in Cooking of Food.

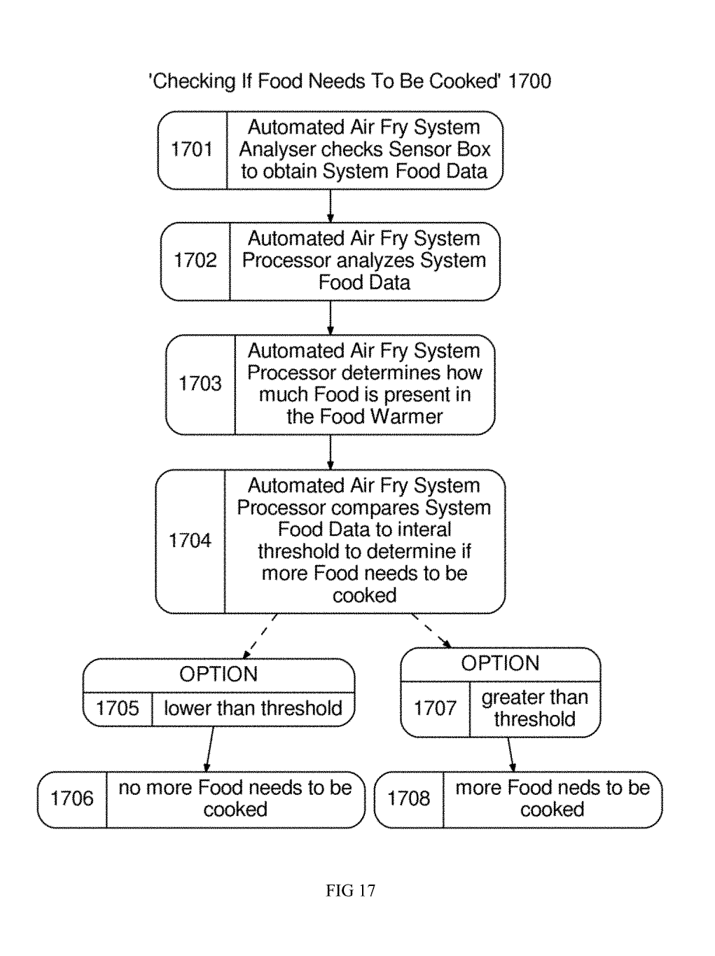

Referring now to FIG. 17, which shows Checking if Food Needs to be Cooked.

In a first step, Automated Air Fryer System Analyzer 1501 checks sensor box 1403 to obtain system food data 1504 (Step 1701). Next, Automated Air Fryer System Processor 1513 analyzes system food data 1504 (Step 1702). Next, Automated Air Fryer System Processor 1513 determines how much food is present in the Food Warmer 503 (Step 1703). Next, Automated Air Fryer System Processor 1513 compares system food data 1504 to interal threshold to determine if more food needs to be cooked (Step 1704). If lower than threshold (Step 1705), then no more food needs to be cooked (Step 1706). From Step 1704, if greater than threshold (Step 1707), then more food neds to be cooked (Step 1708).

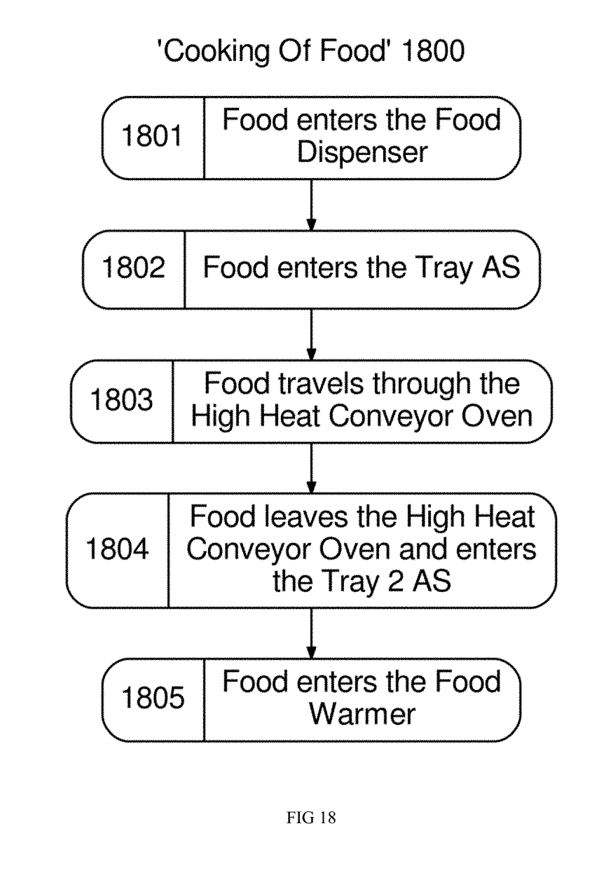

Referring now to FIG. 18, which shows Cooking of Food.

In a first step, food enters the food dispenser 505 (Step 1801). Next, food enters the Tray AS 1201 (Step 1802). Next, food travels through the high heat conveyor oven 507 (Step 1803). Next, food leaves the high heat conveyor oven 507 and enters the Tray 2 AS 1304 (Step 1804). Next, food enters the Food Warmer 503 (Step 1805).

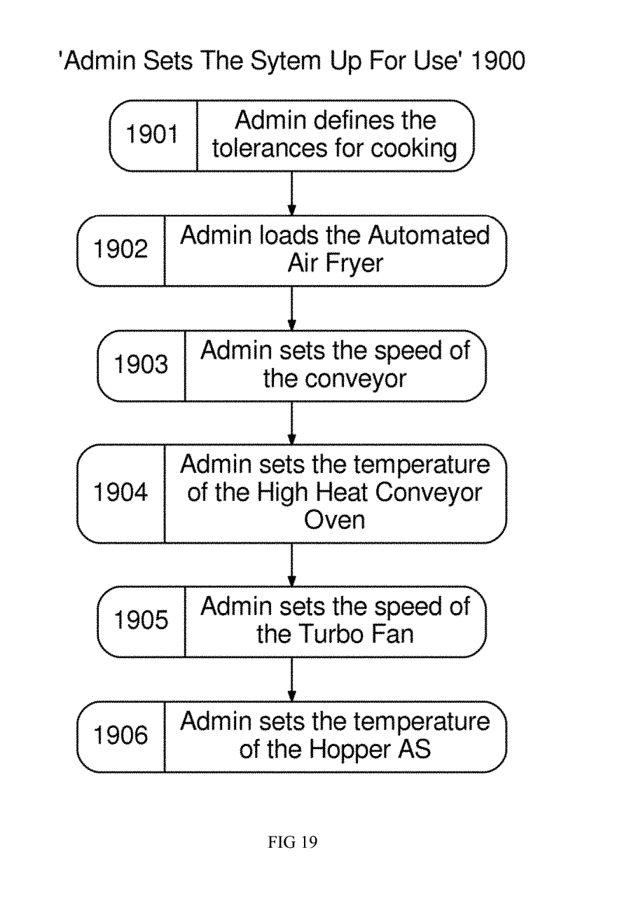

Referring now to FIG. 19, which shows Admin Sets the System Up for Use.

In a first step, admin defines the tolerances for cooking (Step 1901). Next, admin loads the automated air fryer 1514 (Step 1902). Next, admin sets the speed of the conveyor (Step 1903). Next, admin sets the temperature of the high heat conveyor oven 507 (Step 1904). Next, admin sets the speed of the turbo fan (Step 1905). Next, admin sets the temperature of the Hopper AS 905 (Step 1906).

The following elements and/or terms level mount insert, level support, inner plate—housing, food, inner plate aperture, oven, conveyor, more than one compartment, multiple conveyor embodiment, multiple oven, hopper refrigerating mechanism, robotic arm scoop, multi compartment food warmer, medium scoop, large scoop, turbo fan, perforated belt, metal piece, food breakup mechanism, configuration system, program instructions, independent processor, graphical user interface and admin are important for the working functionality, but do not appear in the drawings and are shown below.

Level mount insert comprises attaches the level mount insert to the Frame AS 504.

Level support comprises the supporting system of the Frame AS 504. One goal of level support is to allows the frame structure to be properly calibrated and leveled so that all components are in the proper arrangement and alignment.

Inner plate—housing is attached to housing walls 1001. Inner plate—housing is preferably shaped like rectangle. One goal of inner plate—housing is to the bottom of the Housing AS 1107. Inner plate—housing preferably comprises inner plate aperture.

Food comprises edible products which are capable of being cooked via a high heat conveyor oven 507.

Inner plate aperture comprises a hole in the inner plate—housing which allows for food to exit and leave the Fridge AS 501. Spatially, inner plate aperture is preferably positioned at least 1.0598 inches from the edge of the inner plate—housing. In some embodiments, The length has a preferred length of 8. In some embodiments, The width has a preferred width of 10. One goal of inner plate aperture is to to allow for the food to exit the Housing AS 1107.

Oven comprises an enclosed compartment, as in a kitchen range, for cooking and heating food. One goal of oven is to cook the food. Oven preferably comprises turbo fan.

Conveyor comprises an apparatus which transports food through the oven at a variable rate of speed. In some embodiments, it is thought that if conveyor is absent then the food does not move through the oven. One goal of conveyor is to enables food to travel through the oven and be deposited automatically in the Food Warmer 503 after cooking is completed. Conveyor preferably comprises perforated belt.

More than one compartment comprises a version of the Food Warmer 503 in which there are more than one area in which food can be stored and warmed.

Multiple conveyor embodiment comprises a version of the high heat conveyor oven 507 in which there are more than one conveyor which can be arranged side by side or one on top of the other.

Multiple oven comprises a version of the high heat conveyor oven 507 in which there are multiple ovens that can be set at different temperatures.

Hopper refridgerating mechanism comprises a system for freezing and or refrigerating food. In some embodiments, it is thought that examples of hopper refridgerating mechanism may include: fridge, freezer, or cooler. One goal of hopper refridgerating mechanism is to cool the food that is stored in the Hopper AS 905.

Robotic arm scoop comprises a version of the scoop 502 where a robotic arm is utilized to retrieve the fries from the Food Warmer 503 and give them to customers.

Multi compartment food warmer comprises a version of the Food Warmer 503 where there are more than one compartment for storing and warming food.

Medium scoop comprises an apparatus that is used to remove food from the Food Warmer 503 that is designed to hold 3-4 oz food.

Large scoop comprises an apparatus that is used to remove food from the Food Warmer 503 that can hold is 5-6 oz of food.

Turbo fan comprises an apparatus with rotating blades that creates a current of air for cooling or ventilation at a variable speed. One goal of turbo fan is to move the air within the oven.

Perforated belt comprises a conveyor belt with one or more holes in the belt. One goal of perforated belt is to the holes prevent the food from sticking to the conveyor.

Metal piece comprises an object that is the width of the conveyor. Spatially, metal piece is preferably positioned at the end of the conveyor that is aligned with the food warmer 503. One goal of metal piece is to forces the food off of the conveyor and prevents food from remaining stuck to the conveyor and knocks it off into food warmer.

Food breakup mechanism comprises an apparatus which breaks the food up before it leaves the Hopper AS 905. In some embodiments, it is thought that examples of food breakup mechanism may include: corkscrew, heating mechanism, vibrator, or hydraulic mechanism. One goal of food breakup mechanism is to ensures that any food which is stuck together is broken up before it leaves the Hopper AS 905.

Configuration system comprises a system common to information technology (IT) and web functions that implements configurations or management system.

Program instructions comprises In some embodiments, it is thought that an example of The independent processor could be audio processor or perhaps video processor and the like. In some embodiments, it is thought that examples of program instructions may include: object code, code performed by a compiler, machine code, code produced by an assembler or a linker, byte code, or code executed using an interpreter.

In some embodiments, it is thought that an example of independent processor could be audio processor or perhaps video processor and the like.

Graphical user interface comprises a visual way of interacting with a computer using items such as windows, icons, and menus, used by most modern operating systems.

Admin comprises The person responsible for running, maintaining and setting up the automated air fryer 1514.

I claim:

1. An apparatus for frying food comprising
a. An Automated Air Fryer System Analyzer; and
b. An Automated Air-Frying Machine.

2. The apparatus of claim 1 wherein the Automated Air Fryer System Analyzer further comprises:
a. An Automated Air Fryer Administrative Device;
b. An Air Fryer Processor Data;
c. A Customer Device; and
d. An Information Display System
And wherein the Air-Frying Machine further comprises:
a. A Fridge AS;
b. A Frame AS;
c. A Tray AS;
d. A Tray 2 AS;
e. A High Heat Conveyor Oven;
f. A Sensor System;
g. A Food Warmer;
h. A Food Dispenser;
i. A Bracket; and
j. One or more Scoop.

3. The apparatus of claim 2 wherein the fridge AS further comprises:
a. A Hooper AS;
b. A Lid; and
c. A Housing AS.

4. The apparatus of claim 2 wherein the high heat conveyor oven further comprises:
a. An oven;
b. A metal piece; and
c. A conveyer.

5. The apparatus of claim 4 wherein the oven further comprises a Turbo Fan.

6. The apparatus of claim 4 wherein the conveyor further comprises a Perforated Belt.

7. The apparatus of claim 3 wherein the Hopper AS further comprises:
a. A Food Breakup Mechanism;
b. A Hopper Walls; and
c. A Hopper Refridgerating Mechanism.

8. The apparatus of claim 7 wherein the Hopper Walls further comprise:
a. A Front-Back Plate Hopper;
b. A Side Plate Hopper;
c. A Side Plate Left Hopper; and
d. A Plate Hopper.

9. The apparatus of claim 8 wherein the Front-Back Plate Hopper further comprises:
a. An inclined section of hopper; and
b. An inclined section of hopper 2.

10. The apparatus of claim 2 wherein the sensor system further comprises:
a. An operational sensor; and
b. A Sensor Box.

11. The apparatus of claim 1 wherein the Automated Air Fryer System Analyzer further comprises:
a. An Automated Air Fryer Administrative Device;
b. An Air Fryer Processor Data;
c. A Customer Device; and
d. An Information Display System.

12. An apparatus for frying food comprising
a. An Automated Air Fryer System Analyzer wherein the Automated Air Fryer System Analyzer further comprises:
i. An Automated Air Fryer Administrative Device wherein the Automated Air Fryer Administrative Device further comprises:
1. An Administrative Interface; and
2. An Automated Air Fryer System Processer;
ii. An Air Fryer Processor Data wherein Air Fryer Processor Data further comprises:
1. A Component Data;
2. A System Food Data; and
3. A Customer Data;
iii. A Customer Device wherein the customer device further comprises customer data; and
iv. An Information Display System;
b. An Automated Air-Frying Machine wherein the Air-Frying Machine further comprises:
i. A Fridge AS wherein the Fridge AS further comprises:
1. A Hooper AS;
2. A Lid; and
3. A Housing AS.
ii. A Frame AS;
iii. A Tray AS;
iv. A Tray 2 AS;
v. A High Heat Conveyor Oven wherein the High Heat Conveyer Oven further comprises:
1. A Oven;
2. A Metal Piece; and
3. A Conveyor;
vi. A Sensor System wherein the Sensor System further comprises:
1. A Sensor Box; and
2. An Operational Sensor;
vii. A Food Warmer;
viii. A Food Dispenser;
ix. A Bracket; and
x. One or more Scoop.

13. The apparatus of claim 12 wherein the Hopper AS further comprises:
a. A Food Breakup Mechanism;
b. A Hopper Walls; and
c. A Hopper Refridgerating Mechanism.

14. The apparatus of claim 13 wherein the Hopper Walls further comprise:
d. A Front-Back Plate Hopper;
e. A Side Plate Hopper;
f. A Side Plate Left Hopper; and
g. A Plate Hopper.

15. The apparatus of claim 14 wherein the Front-Back Plate Hopper further comprises:
h. An inclined section of hopper; and
i. An inclined section of hopper 2.

16. An apparatus for the automated frying of food comprising:
a. A Fridge AS wherein the Fridge AS further comprises:
i. A Hopper AS;
ii. A Housing AS; and
iii. A Lid;
b. A Frame AS;
c. A Tray AS;
d. A Tray 2 AS;
e. A High Heat Conveyor Oven;
f. A Sensor System;
g. A Food Warmer;
h. A Food Dispenser;
i. A Bracket; and
j. One or more Scoop.

17. The apparatus of claim 16 wherein the Hopper AS further comprises:
j. A Food Breakup Mechanism;
k. A Hopper Walls; and
l. A Hopper Refridgerating Mechanism.

18. The apparatus of claim 17 wherein the Hopper Walls further comprise:
m. A Front-Back Plate Hopper;
n. A Side Plate Hopper;
o. A Side Plate Left Hopper; and
p. A Plate Hopper.

19. The apparatus of claim 18 wherein the Front-Back Plate Hopper further comprises:
q. An inclined section of hopper; and
r. An inclined section of hopper 2.
